(19) United States
(12) Patent Application Publication
(10) Pub. No.: US 2024/0426654 A1
(43) Pub. Date: Dec. 26, 2024

(54) Device For Monitoring Properties of A Laser Beam

(71) Applicant: II-VI Delaware, Inc., Wilmington, DE (US)

(72) Inventors: Daniel Labahn, Wilmington, DE (US); Danny Chan, Wilmington, DE (US); Patrick Kuhl, Wilmington, DE (US); Romon Chakrabarti, Wilmington, DE (US); Andreas Ziemann, Wilmington, DE (US); Hannes Noack, Wilmington, DE (US)

(21) Appl. No.: 18/368,000

(22) Filed: Sep. 13, 2023

(30) Foreign Application Priority Data
Jun. 22, 2023 (DE) 10 2022 125 129.2

(51) Int. Cl. G01J 1/42; G01J 1/04

(52) U.S. Cl. CPC G01J 1/4257; G01J 1/0411; G01J 1/0414; G01J 1/0425; G01J 1/0437

(57) ABSTRACT

The disclosure relates to a system and method for monitoring a high power laser beam in a laser material processing optical system, and provides a device and method for monitoring a high power laser beam. According to the present disclosure a detailed determination of properties of a high-power laser beam takes place in the direction of an optical fiber or laser beam entering a laser processing head connected to the laser source and these measurements can be performed during the processing operation. The device according to the present disclosure has optical sensors for measuring the intensity and respective current laser power.

### CROSS-REFERENCE TO RELATED APPLICATIONS

The present application claims priority to German Patent Application No. DE 10 2022 125 129.2 filed on Jun. 22, 2023. The aforementioned application is hereby incorporated by reference in its entirety.

### FIELD OF DISCLOSURE

The disclosure relates to a system and method for monitoring properties of a high-power laser beam.

### BACKGROUND OF THE DISCLOSURE

Various methods and devices are known in the state of the art for measuring the properties of high-power laser beams. One disadvantage of the devices and methods known in the state of the art is that they have to intervene in the beam and thus either cannot measure simultaneously with the machining process or represent a risk of contamination.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

The disclosure relates to an improved system and method for monitoring properties of a high-power laser beam, that overcomes disadvantages found in the prior art.

These and other advantages, aspects and novel features of the present disclosure, as well as details of an illustrated embodiment thereof, will be more fully understood from the following description and drawings.

### BRIEF DESCRIPTION OF THE FIGURES

The disclosure is illustrated in more detail below with reference to figures. It will be obvious to those skilled in the art that these are only possible embodiments, without limiting the disclosure to the embodiments shown.

FIG. 1 shows the arrangement of optical elements in one embodiment according to the present disclosure.

FIG. 2 shows an embodiment with a filter in front of the sensor.

FIG. 3 shows an embodiment with an aperture in front of the second lens.

FIG. 4 shows an embodiment with additional optical elements.

### DETAILED DESCRIPTION OF THE DISCLOSURE

Various methods and devices are known in the state of the art for measuring the properties of high-power laser beams. These devices for measure the power of the laser beam and determine the geometric properties of the beam. Such geometric properties include the beam profile, the focus diameter, the divergence angle and other key figures for beam quality. When using a laser beam for material processing such as cutting, welding, surfacing or soldering, these parameters, like the beam power, have an influence on the laser processing process and are therefore decisive for the quality of the processing result. The measurement of these parameters is therefore an essential part of quality assurance in laser material processing.

The present disclosure provides a system and method for monitoring properties of laser beams sources, such as a high-power laser beam source or even collimated laser beams, i.e., a raw beam from a laser. A system according to the present disclosure is used to determine the properties of laser beam entering a laser processing head. In contrast to devices and methods known in the prior art, according to the present disclosure a detailed determination of properties of a high-power laser beam takes place in the direction of the optical fiber connected to the laser source and these measurements can be performed during the machining process. The device according to the present disclosure has optical sensors for measuring the intensity and respective current laser power.

Spatial resolution of the laser beam can be achieved with respect to the position of the laser beam in x- and y-direction, the diameter of the laser beam, the energy distribution in the laser beam as well as the determination of the center of the energy distribution, the wave front and other physical properties of the laser beam along its beam axis, including for example beam diameter and propagation angle.

Further, the apparatus and method according to the present disclosure allow for temporal resolution of the laser beam with respect to unexpected changes in light intensity or a change in sensor signal.

An apparatus and method according to the present disclosure allows the measurement of a z-displaced fiber tip and its compensation. A center of gravity shift of the laser beam can also be measured and compensated for in the z-direction and also in the lateral x- and y-directions.

The device comprises a tunable lens or a group of lenses comprising at least one tunable lens in which the lens properties can be adjusted or a linear drive for changing the position of the lens or lens group in the beam path. The respective lenses or lens groups can be moved in the beam path by displacement elements comprising drives which are connected to them. This also includes a movement of the lenses or lens groups relative to each other.

According to the disclosure, the sensors are a camera, a Shack-Hartmann wavefront sensor, a polarization camera, a hyperspectral camera or a beam-sensitive sensor, and a matrix beam splitter.

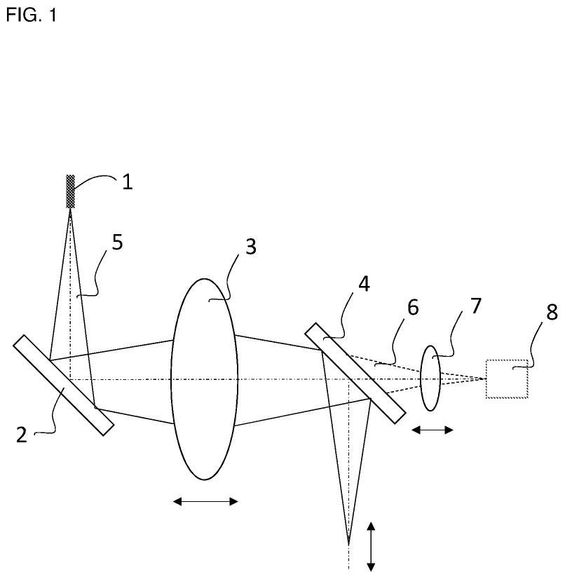

FIG. 1 shows the arrangement of optical elements in a first embodiment of a device according to the present disclosure. A high power laser beam 5 exits the optical fiber 1 connected to the laser beam source (not shown) and is reflected by the first mirror 2. The optical fiber 1 may be an optical fiber cable and the first mirror 2 may be a deformable or tiltable mirror.

The high power laser beam 5 is focused by the first lens 3. A dichromatic mirror 4 is arranged between the first lens 3 and the second lens 7, with which a part 6 of the high-power laser beam 5 is coupled out. The coupled-out part 6 of the laser beam is imaged through the second lens 7 onto the sensor 8 arranged behind it. The part of the high-power laser beam reflected by the dichromatic mirror 4 is used for laser material processing.

The second lens 7 is movably arranged so that it can compensate for movements of the first lens. The second lens 7 is movable asynchronously to the first lens 3 in order to focus on another beam position or to measure the properties of the laser beam.

The sensor 8 and the first lens 3 are arranged in such a way that they can be moved asynchronously to each other. The sensor 8 measures the properties of a laser beam described above. It is also provided in one embodiment of the disclosure that the sensor 8 is formed from a matrix beam splitter in combination with a camera system.

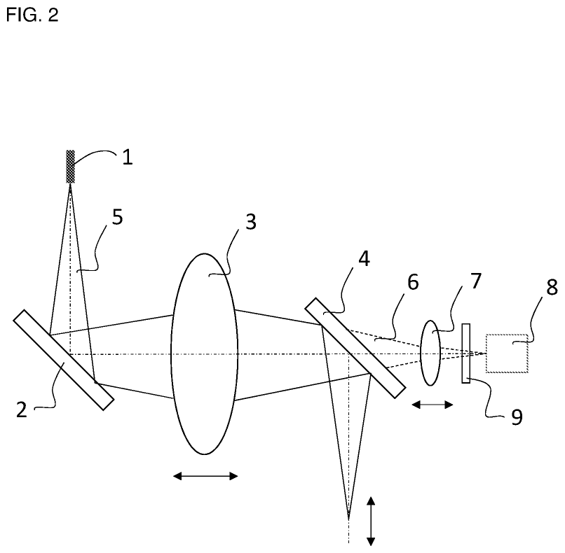

FIG. 2 shows the arrangement of optical elements in an embodiment in which a filter 9 is arranged between second lens (lens group) 7 and sensor 8. Alternatively, the filter can also be arranged between mirror 4 and lens 7. According to the disclosure, it is provided that at least one filter is arranged in the beam path of the outcoupled beam 6. For example, absorption, reflection or polarization filters are provided as filters 9.

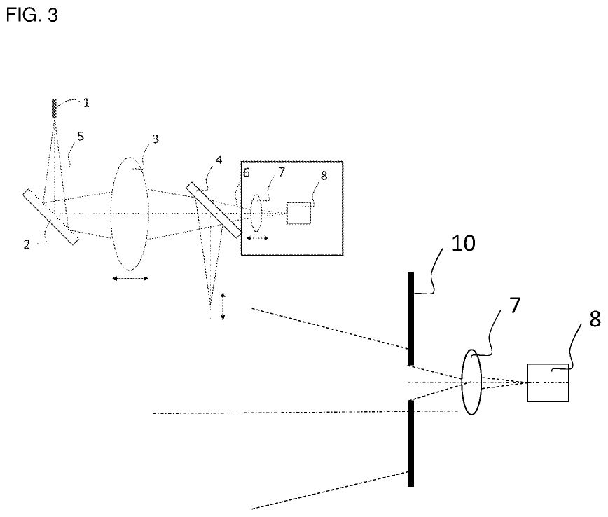

FIG. 3 shows an embodiment in which an aperture 10 is arranged in front of the second lens 7. It is provided in this embodiment that the hole in the aperture 10 is offset with respect to the beam axis. This causes the center of gravity of the beam to shift on the detector 8 when the beam is shifted in the z-direction. This embodiment allows to measure the focus shift in a fixed setup.

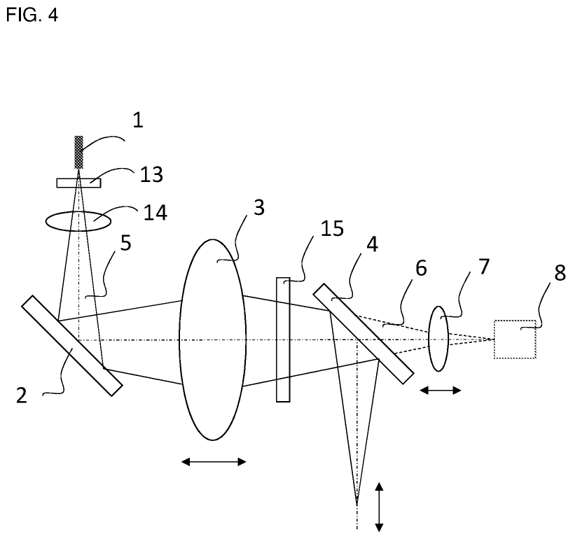

FIG. 4 shows, by way of example, the arrangement of further optical elements in an embodiment in which a protective glass 13 is arranged between the optical fiber 1 and the first mirror 2 to protect the optics against contamination. Furthermore, a third lens or lens group 14 may be arranged in front of the first mirror 2. The beam former 15 behind the first lens 3 may also be arranged elsewhere in the beam path. Beam shapers can influence the focus on the workpiece and thus affect the cut quality, cut speed or cut shape. Assuming a soldering or welding process, the quality of the seam can be positively influenced.

The present disclosure provides a system for monitoring properties of a laser beam entering a laser processing head comprising
an entry port for the laser beam;
a first deflection mirror arranged behind the entry port in the direction of a laser beam path for reflecting the laser beam;
a first lens or lens group arranged behind the first deflection mirror in the direction of the beam path;
a dichromatic mirror arranged behind it in the direction of the beam path for partly coupling the laser beam out;
a second lens arranged behind the dichromatic mirror in the direction of the partly outcoupled laser beam path; and
a sensor arranged behind the second lens in the direction of the partly outcoupled laser beam path, which the partly outcoupled part of the laser beam hits.

According to the disclosure, it is further provided that the entry port for the laser beam is a laser light cable connected to a laser beam source.

It is further provided that the first lens or lens group focuses the laser beam.

In another embodiment, the second lens or lens group focuses the partly outcoupled portion of the laser beam onto the sensor.

Another aspect of the disclosure relates to the first and/or the second lens or lens group, wherein the lens is a so-called tunable lens or the lens group comprises at least one tunable lens comprising liquid lenses, liquid crystalline lenses and lenses made of elastomers whose optical properties are changeable by external excitation such as mechanical or hydrostatic deformation.

The system according to the disclosure further comprises a first lens or lens group connected to a first displacement element and a second lens or lens group connected to a second displacement element for displacing the respective lens or lens group on the beam axis.

According to the disclosure, it is also provided that the sensor is connected to a third displacement element for its displacement along the beam axis.

Another embodiment relates to a system in which an optical filter is arranged between the dichromatic mirror and the sensor.

Another aspect of the disclosure relates to an embodiment in which an aperture is disposed between the dichromatic mirror and the second lens.

Furthermore, a hole of the aperture can be arranged offset to the laser beam axis.

In a further embodiment of the disclosure, a protective glass is arranged behind the tip of the optical fiber in the direction of the laser beam path, and a third lens or lens group is arranged behind the protective glass. The third lens may also be a so-called tunable lens or the lens group comprises at least one tunable lens.

Furthermore, a beam shaping element can additionally be arranged in the laser beam path.

For the first mirror, it is also envisaged that it can be a tip-tilt mirror or a deformable mirror.

Another aspect of the present disclosure relates to a method for determining properties of a high-power laser beam or laser beam entering a laser processing head, wherein a sensor receives an outcoupled portion of a high-power laser beam, wherein the outcoupled portion of the high-power laser beam or laser beam being has been outcoupled by a dichromatic mirror.

The method may further comprise the step of forming the high-power laser beam or laser beam through a first lens arranged before the dichromatic mirror, wherein the first lens is a so-called tunable lens, or the lens group comprises at least one tunable lens.

In the method, the high-power laser beam or laser beam may be shaped by a second lens arranged between the dichromatic mirror and the sensor, the second lens being a so-called tunable lens or the lens group comprising at least one tunable lens.

Furthermore, in one embodiment of the method according to the present disclosure, the high-power laser beam or laser beam can be deflected in the direction of the first lens or lens group by a deflection mirror which is arranged before the first lens or lens group.

The high-power laser beam or laser beam can pass through a filter arranged before the sensor.

Another aspect of the method according to the present disclosure relates to the high-power laser beam or laser beam passing through an aperture arranged offset from the beam axis and before the second lens or lens group.

Ultimately, in the method, the high-power laser beam or laser beam may also pass between an exit aperture of the high-power laser beam and the deflection mirror through a cover aperture and a third lens.

Other aspects, features and advantages of the present disclosure will readily be apparent from the foregoing detailed description, in which simple preferred embodiments and implementations are illustrated. Additional purposes and advantages of the disclosure are set forth in part in the foregoing description and will become apparent in part from the description or may be inferred from the embodiment of the disclosure.

The foregoing description of the preferred embodiment of the disclosure has been given for the purpose of illustration and description. It is not intended to be exhaustive or to limit the disclosure precisely to the disclosed form. The present disclosure may also be realized in other and different embodiments, and its various details may be modified in various obvious aspects, without departing from the teachings and scope of the present disclosure. Accordingly, the drawings and descriptions are to be considered illustrative and not limiting. Modifications and variations are possible in view of the above teachings or may be obtained from practice of the disclosure. The embodiment has been chosen and described to explain the principles of the disclosure and its practical application to enable those skilled in the art to use the disclosure in various embodiments suitable for the particular use intended. It is intended that the scope of the disclosure be defined by the appended claims and their equivalents. The entirety of each of the foregoing documents is incorporated herein by reference.

What is claimed is:

1. A system for monitoring properties of laser beam entering a laser processing head, comprising
an entry port for the laser beam;
a first deflection mirror arranged behind the entry port in the direction of a laser beam path for reflecting the laser beam;
a first lens or lens group arranged behind the first deflection mirror in the direction of the beam path;
a dichromatic mirror arranged in the direction of the beam path for partly coupling the laser beam out;
a second lens arranged behind the dichromatic mirror in the direction of the partly outcoupled laser beam path; and
a sensor arranged behind the second lens in the direction of the partly outcoupled laser beam path, which the partly outcoupled part of the laser beam hits.

2. The system of claim 1, wherein the laser beam entry port is a laser light cable connected to a laser beam source.

3. The system of claim 1, wherein the first lens or lens group focuses the laser beam.

4. The system of any one of claims 1 to 3, wherein the second lens or lens group focuses the partly outcoupled portion of the laser beam onto the sensor.

5. The system of any one of claims 1 to 4, wherein the first and/or second lens or lens group is a tunable lens or the lens group comprises at least one tunable lens, wherein the optical properties of a tunable lens are changeable by external excitation.

6. The system of any one of claims 1 to 5, wherein the first lens or lens group is connected to a first displacement element and the second lens or lens group is connected to a second displacement element for displacing the respective lens or lens group on the beam axis.

7. The system of any one of claims 1 to 6, wherein the sensor is connected to a third displacement device for displacement thereof along the beam axis.

8. The system of any one of claims 1 to 7, wherein an optical filter is disposed between the dichromatic mirror and the sensor.

9. The system of any one of claims 1 to 8, wherein an aperture is disposed between the dichromatic mirror and the second lens.

10. The system of claim 9, wherein a hole of the aperture is offset from the beam axis of the laser beam.

11. The system of any one of claims 1 to 10, wherein a protective glass is disposed behind the tip of the optical fiber in the direction of the beam path of the laser beam, and a third lens or lens group is disposed behind the protective glass.

12. The system of any one of claims 1 to 11, wherein the third lens is a tunable lens or the lens group comprises at least one tunable lens.

13. The system according to any one of claims 1 to 12, wherein a beam shaping element is additionally arranged in the beam path.

14. A system according to any one of claims 1 to 13, wherein the first mirror is a tip-tilt mirror or deformable mirror.

15. A method for determining properties of a high-power laser beam or laser beam entering a laser processing head, wherein a sensor receives an outcoupled portion of a high-power laser beam or laser beam, wherein the outcoupled portion of the high-power laser beam or laser beam is outcoupled by a dichromatic mirror.

16. The method of claim 16, wherein the high-power laser beam or laser beam is formed by a first lens or lens group arranged before of the dichromatic mirror, wherein the first lens is a so-called tunable lens, or the lens group comprises at least one tunable lens.

17. The method of any one of claim 15 or 16, wherein the high-power laser beam or laser beam is formed by a second lens or lens group arranged between dichromatic mirror and sensor, wherein the second lens is a so-called tunable lens, or the lens group comprises at least one tunable lens.

18. The method of any one of claims 15 to 17, wherein the high-power laser beam or laser beam is deflected by a deflection mirror which is arranged before the first lens or lens group toward the first lens or lens group.

19. The method of any one of claims 15 to 18, wherein the high-power laser beam or laser beam passes through a filter arranged before the sensor.

20. The method of any one of claims 15 to 19, wherein the high-power laser beam or laser beam passes through an aperture arranged offset from the beam axis and before the second lens or lens group.
